(19) United States
(12) Patent Application Publication
(10) Pub. No.: US 2020/0273455 A1
(43) Pub. Date: Aug. 27, 2020

(54) SYSTEM FOR CONTROLLING APPLICATION DEVICES BY USING DIALOGUE OR SOCIAL MEDIA

(71) Applicant: CHIEN-CHIH KUO, New Taipei City (TW)

(72) Inventor: CHIEN-CHIH KUO, New Taipei City (TW)

(21) Appl. No.: 16/286,537

(22) Filed: Feb. 26, 2019

(51) Int. Cl. G10L 15/22; G06F 16/9032; G10L 15/30; H04M 1/725

(52) U.S. Cl. CPC G10L 15/22; H04M 1/72527; G10L 15/30; G06F 16/90332

(57) ABSTRACT

A system for controlling application devices by using dialogue or social media includes a first dialogue unit being a dialogue unit with respect to a specific dialogue software unit; the first dialogue unit including a first dialogue frame, a first user interface, and a first output unit; the first dialogue unit being installed in a first electronic device; a second dialogue unit signally connected to the first dialogue unit; the second dialogue unit including a second dialogue frame, a second user interface, and a second output unit; the second dialogue unit being installed in a second electronic device; at least one application device connected to the second dialogue unit in the second electronic device; and a downlink converter connected to the second dialogue unit for converting statements in the second dialogue unit into mechanical instructions; and then the mechanic instructions are transferred out through a network to the application device.

### FIELD OF THE INVENTION

The present invention is related to remote machine control, and in particular to a system for controlling application devices by using dialogue or social media.

### BACKGROUND OF THE INVENTION

To remote control various machines by using handsets is a trend in the networking applications. For example, to control different lamps, cooking devices, TVs, etc. by using a handset so that when a person does not stay in a house, he or she can control the light or other electronic devices.

Generally, for controlling the electric or electronic devices (in the following, they are called as application devices), an APP dedicated to the application device is downloaded through the network system to the handset, and then the user control the application device through the handset. Because there are various kinds of application devices which are different brands or kinds, the APPs for these application devices are not compatible and thus the user must download various kinds of APP for controlling these application devices. Moreover, the user must remember different instructions and control ways for these APPs. However, this is inconvenient to users.

Moreover, most of people use dialogue media or social media in talking to each other and they are familiar with these media. Therefore, inventor of this invention desire to improve above mentioned defects by using this novel technology.

### SUMMARY OF THE INVENTION

Accordingly, the object of the present invention is to provide a system for controlling application devices by using dialogue or social media, by which, a user can control various application devices by using a general used dialogue media or a social media without needing to download a dedicated APP for the application. Furthermore, different kinds of application devices only install the APP provided by the present invention for converting the statement instructions into mechanical acceptable instructions. The present invention may provide suggestion instructions so that the user need not remember the instructions. Various kinds or brands of application devices may be controlled under a same dialogue frame of the same social medial or dialogue media.

To achieve above object, the present invention provides a a system for controlling application devices by using dialogue or social media, comprising: a first dialogue unit being a dialogue unit with respect to a specific dialogue software unit; the first dialogue unit including a first dialogue frame, a first user interface, and a first output unit; a user can register into the first dialogue unit through the first user interface so as to dialogue through the first dialogue frame; the first dialogue unit being installed in a first electronic device; a second dialogue unit signally connected to the first dialogue unit and being a dialogue unit with respect to the specific dialogue software unit; the second dialogue unit including a second dialogue frame, a second user interface, and a second output unit; the second dialogue unit being installed in a second electronic device; at least one application device connected to the second dialogue unit in the second electronic device; a user can register into the second dialogue unit through the second user interface for dialoging with others; and a downlink converter connected to the second dialogue unit for converting statements in the second dialogue unit into mechanical instructions; and then the mechanic instructions are transferred out through a network to the application device.

### BRIEF DESCRIPTION OF THE DRAWINGS

FIG. 1 is a structural schematic view of the present invention.

FIG. 2 shows the first application of the present invention.

FIG. 3 shows the second application of the present invention.

FIG. 4 shows the third application of the present invention.

FIG. 5 shows the dialogue frame in the third application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

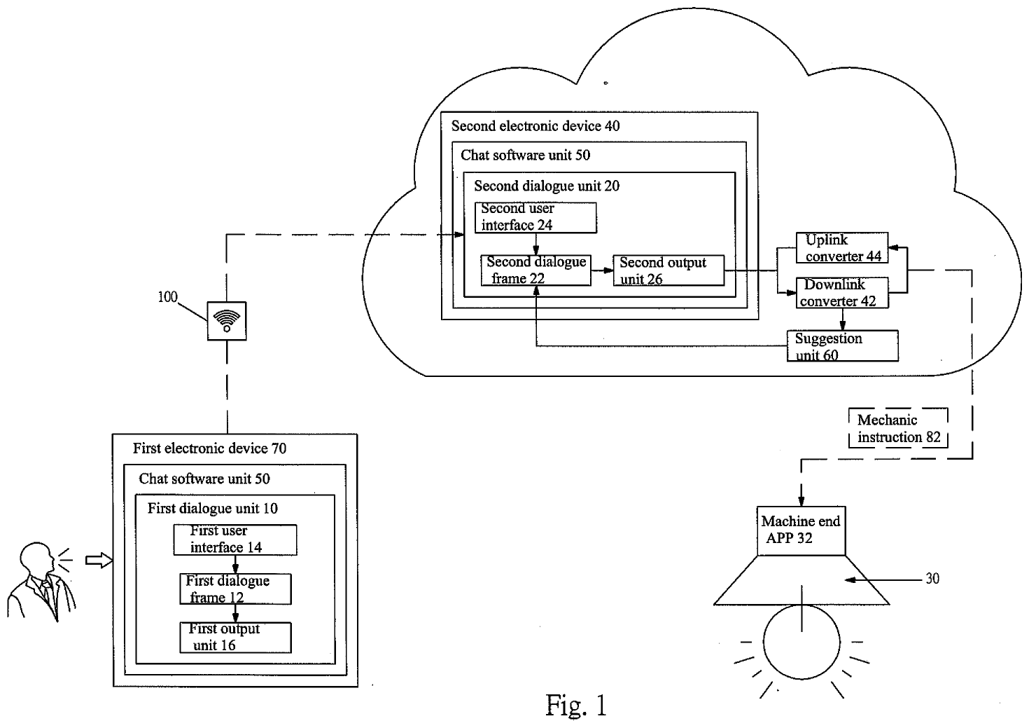

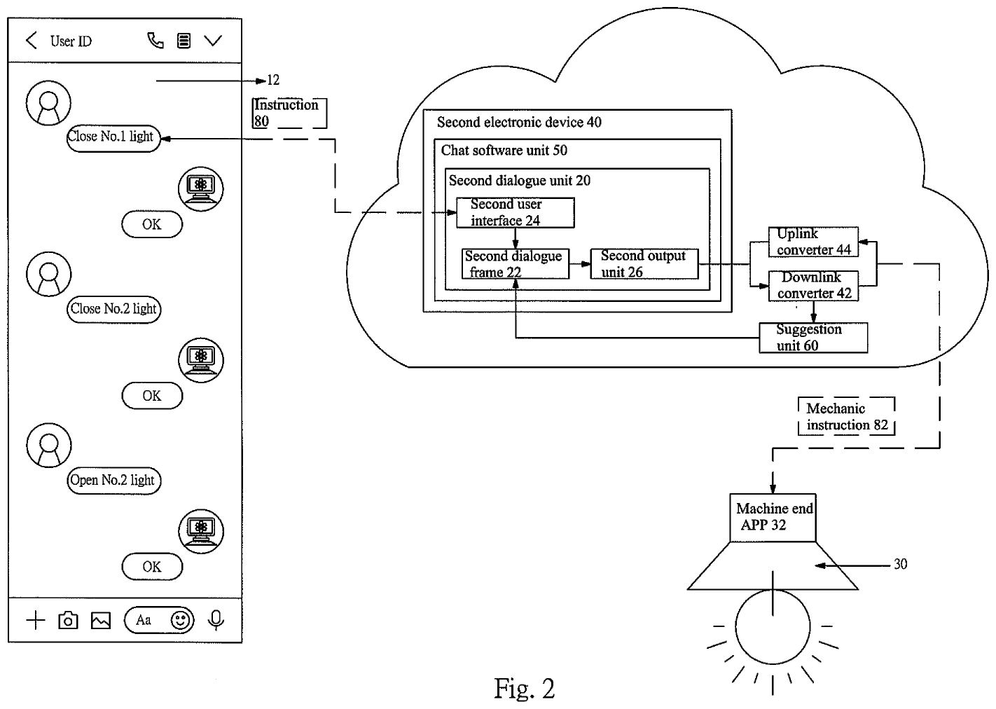

With reference to FIGS. 1 to 5, the structure of the present invention is illustrated. In the invention, the so called dialogue media or social media includes various kinds of dialogue media, such as Line, wechat, Instagram, etc. and also includes various kinds of social media, such as QQ, Facebook, etc. All these media are built in various electronic devices, such as handsets, computers, tablet computers, notebook computers, PDA, etc. The present invention includes the following elements.

A first dialogue unit 10 is a dialogue unit with respective to a specific chat software unit 50. The first dialogue unit 10 includes a first dialogue frame 12, a first user interface 14, and a first output unit 16. A user may register into the first dialogue unit 10 through the first user interface 14 so as to dialogue through the first dialogue frame 12. The first dialogue unit 10 is installed in a first electronic device 70, such as a handsets, computers, tablet computers, notebook computers, PDA, etc. The dialogue software unit 50 includes various kinds of dislogue software, such as Line, wechat, Instagram, etc. and also includes various kinds of social software, such as QQ, Facebook, etc.

The second dialogue unit 20 is signally connected to the first dialogue unit 10 and is a dialogue unit with respect to the specific chat software unit 50. The second dialogue unit 20 includes a second dialogue frame 22, a second user interface 24, and a second output unit 26. In the present invention, the second dialogue frame 22 may be a virtual unit, that is, there may be no any real frame being displayed on an electronic device, but it is a virtual frame for communicating dialogues from two sides. The second dialogue unit 20 is installed in a second electronic device 40, such as a server, a handset, a computer, a tablet computer, a notebook computer, etc. Preferably, the second electronic device 40 is arranged as a cloud device so that a plurality of application devices may be connected thereto.

At least one application device 30 is connected to the second dialogue unit 20 in the second electronic device 40. A user can register into the second dialogue unit 20 through the second user interface 24 for dialoging with others.

A downlink converter 42 is connected to the second dialogue unit 20 for converting statements in the second dialogue unit 20 into mechanical instructions. Then the mechanic instructions are transferred out through a network. In the present invention, the downlink converter 42 further includes a checkout mechanism. When the second dialogue unit 20 receives a dialogue statement, the dialogue statement is firstly transferred to the downlink converter 42 for checking whether the dialogue statement is acceptable by the application device 30. If yes, the dialogue statement is converted into a mechanic instruction and then the instruction is transferred to the application device 30 through a network. If in transformation of the dialogue statement into an instruction, it is discovered that the dialogue statement is not a statement which is acceptable by the application device 30, an error instruction 86 is transferred back to the first dialogue unit 10 through the network 100 so that the error instruction 86 is displayed in the first dialogue frame 12.

An uplink converter 44 is connected to the application device 30 and the second dialogue unit 20 for converting the instructions from the application device 30 into a dialogue statement which is acceptable by the chat software unit and then the dialogue statement is transferred to the second dialogue unit 20.

Applications of the present invention will be described herein with reference to FIG. 1. In downlink connection, a user gives a statement instruction 80 (such as a statement of switching on), which has a form of a statement, through the first dialogue unit 10 of the chat software unit 50. The statement instruction 80 is transferred to the second dialogue unit 20 in the cloud through the first output unit 16 and the network system 100. Then it is converted into a mechanic instruction 82 by using the downlink converter 42. Then the mechanic instruction 82 is transferred to a device APP 32 in an application device 30 through the network system 100 so that the application device 30 could perform the mechanic instruction 82, for example to light up a lamp.

Another, when the mechanic instruction 82 is performed, the application device 30 may generate an action complete instruction 84 which is then transferred to the uplink converter 44 through the network system 100. The uplink converter 44 converts the action instruction into a statement instruction (which has a form like a statement spoken by a person) and then the statement instruction is transferred to the first dialogue unit 10 in first electronic device 70 through the second dialogue unit 20 so as to display the statement instruction on the first dialogue frame 12. Therefore, a user may understand the state of the application device 30. The whole process is like a dialogue by using a general used chat media or social media.

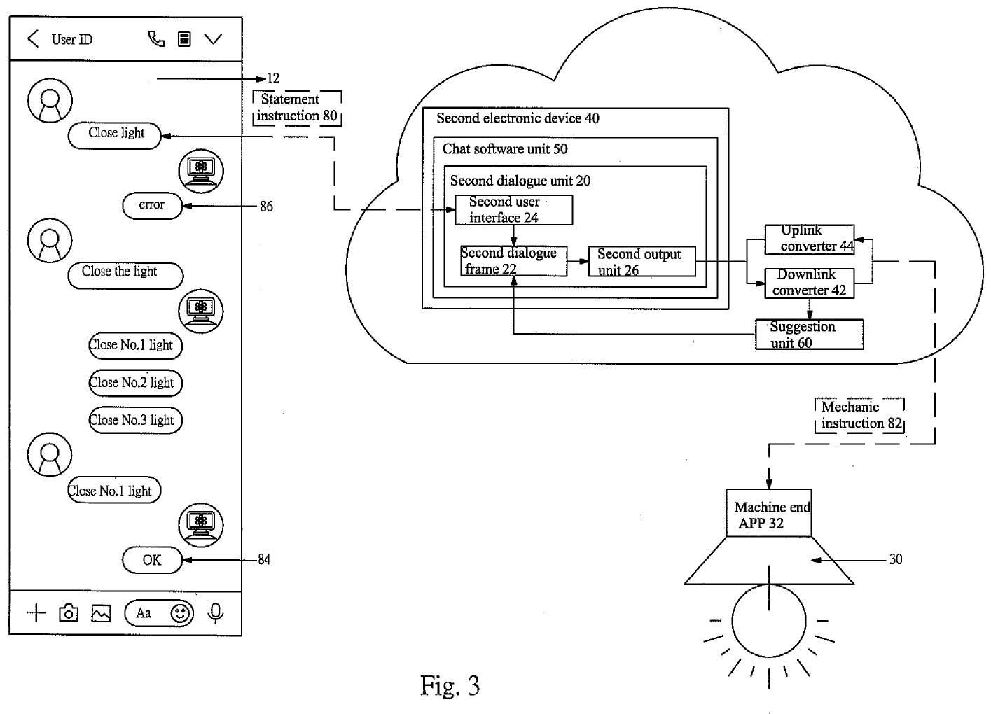

With reference to FIG. 3, the present invention further includes a suggestion unit 60. After the statement instructions is converted by the downlink converter 42, when the downlink converter 42 identifies that the dialogue statement from the first dialogue unit 10 is not an acceptable instruction by the application device 30, the suggestion unit 60 finds at least one instruction which is acceptable by the application device 30 and is corresponding to or near the dialogue statement originally emitted by the user. This instruction may be displayed by using a form of statement or a drawing. The suggestion instruction is transferred back to the first dialogue unit 10 in the first electronic device 70 by the second dialogue unit 20 to be selected by the user. After selection, the selected instruction is transferred according to above mentioned process.

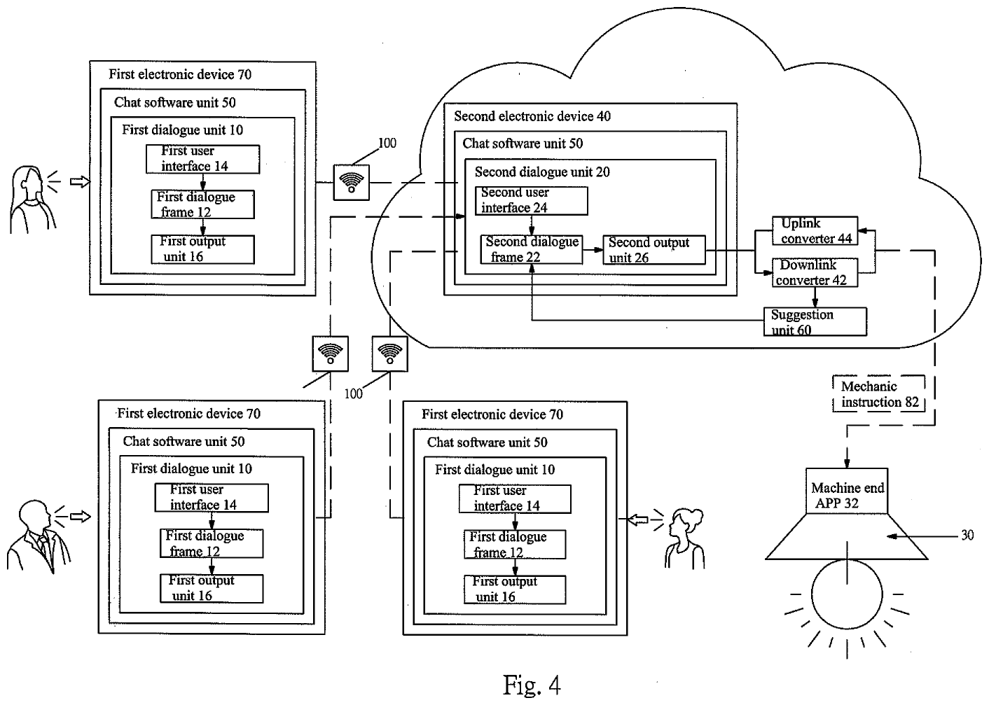

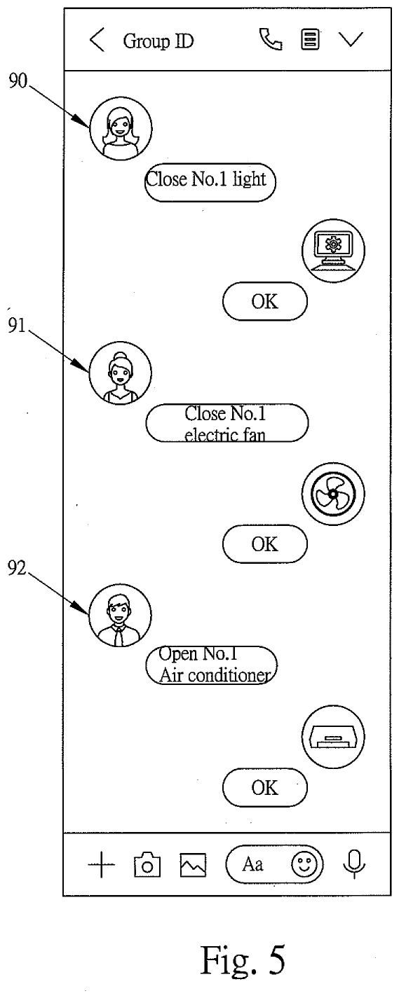

A machine end APP 32 is installed in the application device 30 for receiving the mechanic instruction from the downlink converter 42 and causing the application device 30 to perform the mechanic instruction. With reference to FIGS. 4 and 5, in the present invention, the first dialogue unit 10 may be formed with a dialogue group. That is, a plurality of application devices 30 and a plurality of users 90, 91, 92 are connected to the first dialogue unit 10. The users 90, 91, 92 are connected to the first dialogue unit 10 through the first dialogue unit 10 of his (or her) first electronic device 70 so as to form as a group. Therefore, the plurality of users 90, 91, 92 may control the application devices 30 and can understand the states of the application devices 30. If a user operates the application devices 30, other users may know the state.

In above mentioned structure, at least one of the users may be set with the right for controlling the application devices 30, while others have no right to control the application devices 30, but just can view the states. That is, the downlink converter 42 may identify whether the instructions are from the at least one user having the right to control the application devices 30.

Advantages of the present invention are that: the user may control various application devices by using a general used dialogue media or a social media without needing to download a dedicated APP for the application. Furthermore, different kinds of application devices only install the APP provided by the present invention for converting the statement instructions into mechanical acceptable instructions. The present invention may provide suggestion instructions so that the user need not remember the instructions. Various kinds or brands of application devices may be controlled under a same dialogue frame of the same social medial or dialogue media. See FIG. 5, a plurality of uses (such as family members, coworkers, or people of the same group, etc.) can monitor various application devices at the same dialogue frame.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system for controlling application devices by using dialogue or social media, comprising:
a first dialogue unit being a dialogue unit with respect to a specific dialogue software unit; the first dialogue unit including a first dialogue frame, a first user interface, and a first output unit; a user can register into the first dialogue unit through the first user interface so as to dialogue through the first dialogue frame; the first dialogue unit being installed in a first electronic device;
a second dialogue unit signally connected to the first dialogue unit and being a dialogue unit with respect to the specific dialogue software unit; the second dialogue unit including a second dialogue frame, a second user interface, and a second output unit; the second dialogue unit being installed in a second electronic device;
at least one application device connected to the second dialogue unit in the second electronic device; a user can register into the second dialogue unit through the second user interface for dialoging with others; and
a downlink converter connected to the second dialogue unit for converting statements in the second dialogue unit into mechanical instructions; and then the mechanic instructions are transferred out through a network to the application device.

2. The system for controlling application devices by using dialogue or social media as claimed in claim 1, further comprising an uplink converter connected to the application device and the second dialogue unit for converting instructions from the application device into a dialogue statement which is acceptable by the dialogue software unit and then the dialogue statement is transferred to the second dialogue unit.

3. The system for controlling application devices by using dialogue or social media as claimed in claim 1, further comprising:
a suggestion unit; after a statement instruction emitted by a user being converted by the downlink converter, when the downlink converter identifying that the dialogue statement from the first dialogue unit is not an acceptable instruction by the application device, the suggestion unit finding at least one instruction which is acceptable by the application device and is corresponding to or near the dialogue statement originally emitted by the user; the suggestion instruction is transferred back to the first dialogue unit in the first electronic device by the second dialogue unit to be selected by the user.

4. The system for controlling application devices by using dialogue or social media as claimed in claim 1, wherein the suggestion instructions are displayed by a form of a statement or a drawing.

5. The system for controlling application devices by using dialogue or social media as claimed in claim 1, further comprising a machine end APP is installed in the application device for receiving the mechanic instruction from the downlink converter and causing the application device to perform the mechanic instruction.

6. The system for controlling application devices by using dialogue or social media as claimed in claim 1, wherein the first dialogue unit has a form of a dialogue group; that is, at least one application devices and a plurality of users are connected to the first dialogue unit; the users are connected to the first dialogue unit through the first dialogue unit of his (or her) first electronic device.

7. The system for controlling application devices by using dialogue or social media as claimed in claim 1, wherein the so called dialogue media and social media are selected from Line, wechat, Instagram, QQ, Facebook.

8. The system for controlling application devices by using dialogue or social media as claimed in claim 1, wherein the first dialogue unit is installed in one of a handsets, computers, tablet computers, notebook computers, and PDAs.

9. The system for controlling application devices by using dialogue or social media as claimed in claim 1, wherein the second dialogue frame is a virtual frame, that is, there is no any real frame being displayed on the second electronic device, but it is a virtual frame for communicating dialogues from the user and statement from the application devices.

10. The system for controlling application devices by using dialogue or social media as claimed in claim 1, wherein the second dialogue unit is installed in a cloud device.

11. The system for controlling application devices by using dialogue or social media as claimed in claim 1, wherein the downlink converter further includes a checkout mechanism. when the second dialogue unit receives a dialogue statement, the dialogue statement is firstly transferred to the downlink converter for checking whether the dialogue statement is acceptable by the application device; if it is acceptable, the dialogue statement is converted into a mechanic instruction and then the instruction is transferred to the application device through a network; if in conversion of the dialogue statement into a mechanic instruction, it is discovered that the dialogue statement is not a statement which is acceptable by the application device, an error statement instruction is transferred back to the first dialogue unit through the network and the error statement instruction is displayed in the first dialogue frame.

12. The system for controlling application devices by using dialogue or social media as claimed in claim 1, wherein at least one of the users is set with the right for controlling the application devices, while others have no right to control the application devices, but they can view the states; that is, the downlink converter identifies whether the instructions are from the at least one user having the right to control the application devices.
